(19) United States
(12) Patent Application Publication
(10) Pub. No.: US 2015/0101818 A1
(43) Pub. Date: Apr. 16, 2015

(54) METHOD OF DELAYING CROSSLINKING IN WELL TREATMENT OPERATION

(71) Applicant: Baker Hughes Incorporated, Houston, TX (US)

(72) Inventors: D.V. Satyanarayana Gupta, The Woodlands, TX (US); Kay Elaine Cawiezel, Fulshear, TX (US)

(21) Appl. No.: 14/577,288

(22) Filed: Dec. 19, 2014

Related U.S. Application Data
(62) Division of application No. 13/364,474, filed on Feb. 2, 2012.

(51) Int. Cl. C09K 8/68; E21B 43/26

(52) U.S. Cl. CPC C09K 8/685; E21B 43/26
USPC 166/308.5

(57) ABSTRACT

Crosslinking of a crosslinkable viscosifying agent and a crosslinking agent may be delayed in a well treatment fluid by incorporated within the fluid a glutamic-N,N-diacetic acid salt, such as a glutamic-N,N-diacetic acid sodium salt like tetrasodium glutamate diacetate. The crosslinking agent may be a zirconium containing crosslinking agent like zirconium (IV) acetyl acetonate. The viscosifying agent may be guar or a guar derivative such as carboxyalkyl guars and hydroxyalkylated guars like carboxymethyl guar, hydroxypropyl guar, hydroxyethyl guar, hydroxybutyl guar and carboxymethylhydroxypropyl guar.

### SPECIFICATION

This application is a divisional application of U.S. patent application Ser. No. 13/364,474, filed on Feb. 2, 2012.

### FIELD OF THE INVENTION

The invention relates to a method of delaying crosslinking during a well treatment operation by introducing into the wellbore a fluid containing a glutamic acid-N,N-diacetic acid salt.

### BACKGROUND OF THE INVENTION

Hydraulic fracturing is the process of enhancing oil and/or gas production from producing wells or enhancing the injection of water or other fluids into injection wells. Typically, a fracturing fluid is injected into the well, passing down the tubulars to the subterranean formation penetrated by the wellbore. The fluid is then pumped at rates and pressures that exceed the confining stresses in the formation, causing the formation to fail by inducing a fracture. This fracture originates at the wellbore and extends in opposite directions away from the wellbore. As more fluid is injected, the length, width and height of the fracture continue to extend. At a point, the width increases so that propping agents are added to the fluid and carried to the fracture and placed in the growing crack. The viscosity of such fluids is sufficient to adequately carry and place proppant into the formation.

The fracturing fluid typically contains a viscosifying agent, such as a water-soluble polymer, which is hydratable in water and a crosslinking agent. Interaction of the polymer and crosslinking agent increases fluid viscosity. Water-soluble polymers for use in fracturing fluids include those based on guar gum and guar derivatives as well as cellulosic derivatives, xanthan, diutan, and carrageenan. Commonly used crosslinking agents are those containing a metal ion such as aluminum, zirconium and titanium as well as those capable of providing borate ions. Such viscosified fluids form three-dimensional gels.

Certain subterranean formations subjected to hydraulic fracturing are water sensitive. For instance, formations rich in swellable and migrating clays are water sensitive due to the presence of kaolinite, chlorite, illite and mixed layers of illite and smectite. It is therefore desired when treating such formations to minimize the amount of water in the fracturing fluid such as by energizing or foaming the fluid. Energized or foamed fluids are particularly applicable to under-pressured gas reservoirs and wells which are rich in swellable and migrating clays. Fluids are typically energized with gases, such as nitrogen and carbon dioxide, to minimize the amount of liquids introduced into the formation and to enhance recovery of the fluids. In some cases, a mixture of such gases may be used. Typically, fluids are considered energized if the volume percent of the energizing medium to the total volume of the treatment fluid (defined as “quality”) is less than 53%; they are considered as foams if the volume percent is greater than 53%.

The fluid introduced into the wellbore may contain a crosslink delaying agent. It is often desirable that the fluid have a crosslink delay mechanism in order to minimize friction, i.e., avoid having to pump a highly viscous fluid in light of high horsepower requirements. Typically, fracturing fluids encounter high shear while they are being pumped through the tubing which penetrates the wellbore. A delay in crosslinking through a high-shear wellbore environment minimizes shear degradation and loss of fluid viscosity. Most crosslink delaying agents are ineffective when the fracturing fluid is subjected to high shear. This is especially the case when the crosslinking agent employed contains a metal, such as zirconium.

It is desired therefore to develop a method of fracturing a formation using a fracturing fluid having time-delay crosslinking.

It is particularly desired to develop a method of fracturing a formation using a fracturing fluid which contains a metal crosslinking agent, such as zirconium, which is capable of time-delay crosslinking, especially when the fluid is subjected to high shear.

Further, it is desirable to develop a method of fracturing using a fracturing fluid which contains a gas, such as nitrogen and carbon dioxide, and which exhibits delayed crosslinking especially when the crosslinking agent contains a metal, such as zirconium and/or the fluid is subjected to high shear.

### SUMMARY OF THE INVENTION

Delaying crosslinking between a viscosifying agent and a crosslinking agent during a hydraulic fracturing operation may be effectuated by including in the fluid introduced into the wellbore a crosslink delaying agent comprising a glutamic-N,N-diacetic acid salt. The use of glutamic-N,N-diacetic acid salt delays the time for formation of the gel resulting from the crosslinking of the viscosifying agent and crosslinking agent.

The glutamic-N,N-diacetic acid salt is preferably a glutamic-N,N-diacetic acid sodium salt such as tetrasodium glutamate diacetate.

Typically, the amount of glutamic acid-N,N-diacetic acid salt in the fluid ranges from about 1 to about 10 pounds per 1,000 gallons of the fluid.

In a preferred embodiment, the crosslinking agent is a metal containing crosslinking agent, such as a zirconium containing crosslinking agent. Particularly preferred is zirconium (IV) acetyl acetonate.

Preferred viscosifying agents include guar and guar derivatives such as carboxyalkyl guars and hydroxyalkylated guars. Exemplary guar derivatives include carboxymethyl guar, hydroxypropyl guar, hydroxyethyl guar, hydroxybutyl guar and carboxymethylhydroxypropyl guar.

The delay in crosslinking does not affect the properties of the fluid when the fluid is subjected to high shear.

### BRIEF DESCRIPTION OF THE DRAWINGS

In order to more fully understand the drawings referred to in the detailed description of the present invention, a brief description of each drawing is presented, in which:

FIG. 1 demonstrates stability performance of a crosslinked fluid which does not contain a glutamic acid-N,N-diacetic acid salt.

FIG. 2 demonstrates the effectiveness over 60 minutes of glutamic acid-N,N-diacetic acid salt as a crosslink delaying agent in a fluid.

FIG. 3 demonstrates the effectiveness over 270 minutes of glutamic acid-N,N-diacetic acid salt as a crosslink delaying agent in a fluid.

FIG. 4 demonstrates the effectiveness over 210 minutes of glutamic acid-N,N-diacetic acid salt as a crosslink delaying agent in a fluid subjected to high shear.

### DETAILED DESCRIPTION OF THE PREFERRED EMBODIMENTS

A hydraulic fracturing operation may proceed by introducing into the wellbore an aqueous fluid which contains a glutamic-N,N-diacetic acid salt. The glutamic-N,N-diacetic acid salt delays crosslinking between a viscosifying agent and a crosslinking agent present in the fluid. The presence of the glutamic-N,N-diacetic acid salt retards or prevents crosslinking between the viscosifying agent and the crosslinking agent.

In a preferred embodiment, a subterranean formation penetrated by an oil or gas well may be stimulated to produce hydrocarbons by injecting at high pressure into the formation a fracturing fluid containing a crosslinkable viscosifying agent, crosslinking agent and the glutamic-N,N-diacetic acid salt.

Preferred glutamic-N,N-diacetic acid salts are alkali salts, such as glutamic-N,N-diacetic acid sodium salt; particularly preferred is tetrasodium glutamate diacetate.

The glutamic-N,N-diacetic acid salt may be used as pure glutamic-N,N-diacetic acid salt as well as glutamic-N,N-diacetic acid salt diluted with water. When diluted with water, the amount of water in the glutamic-N,N-diacetic acid salt component should be no greater than 95 percent by weight. Preferably, the amount of water in the aqueous salt solution is between from about 50 to about 95 weight percent.

The glutamic-N,N-diacetic acid salt is present in the treatment fluid in a concentration of from about 10 to about 1,000, more preferably less than about 80, most preferably less than about 25, pounds per 1,000 gallons of fluid.

The crosslinking agent may comprise any suitable metallic crosslinker known in the art. In a preferred embodiment, the metal crosslinking agent contains either aluminum, titanium, zirconium, aluminum, iron or antimony or a mixture thereof. In a preferred embodiment, the crosslinker contains zirconium. Examples of zirconium salts include zirconium ammonium carbonate, zirconium chloride, zirconium oxychloride, sodium zirconium lactate, zirconium malate, zirconium citrate, zirconium oxyacetate, zirconium acetate, zirconium oxynitrate, zirconium sulfate, tetrabutoxyzirconium, zirconium monoacetyl acetonate, zirconium normal butyrate and zirconium normal propylate, zirconium glycolate and zirconium lactate triethanolamine. In a preferred embodiment, the fluid does not contain triethanolamine which is often deemed to be unacceptable for export and international use. In a most preferred embodiment, the zirconium salt is a zirconium monoacetyl acetonate, such as zirconium (IV) acetyl acetonate.

The amount of crosslinking agent present in the aqueous fluid is that amount required to effectuate gelation or viscosification of the fluid at or near the downhole temperature of the targeted area, typically between from about 0.5 gpt to about 5 gpt based on the liquid volume of the aqueous fluid.

The viscosifying agent is typically a hydratable natural or a synthetic polymer.

Preferred viscosifying agents include crosslinkable polysaccharides like guar gums and derivatives, cellulosic derivatives, starch, and galactomannan gums.

Specific guar gum derivatives include carboxyalkyl guars and hydroxyalkylated guars. Especially preferred are carboxymethyl guar, hydroxypropyl guar, hydroxyethyl guar, hydroxybutyl guar and carboxymethylhydroxypropyl guar. In an embodiment, the hydroxyalkylated guar may have a molecular weight of about 1 to about 3 million. The carboxyl content of the hydratable polysaccharides is expressed as Degree of Substitution (“DS”) and ranges from about 0.08 to about 0.18 and the hydroxypropyl content is expressed as Molar Substitution (MS) (defined as the number of moles of hydroxyalkyl groups per mole of anhydroglucose) and ranges between from about 0.2 to about 0.6.

Cellulosic derivatives include alkylcellulose, hydroxyalkyl cellulose or alkylhydroxyalkyl cellulose, carboxyalkyl cellulose derivatives such as hydroxyethyl cellulose, hydroxypropyl cellulose, hydroxybutyl cellulose, hydroxyethylmethyl cellulose, hydroxypropylmethyl cellulose, hydroxybutylmethyl cellulose, methylhydroxyethyl cellulose, methylhydroxypropyl cellulose, ethylhydroxyethyl cellulose, carboxyethylcellulose, carboxymethylcellulose and carboxymethylhydroxyethyl cellulose.

Other suitable polysaccharides and derivatives are those which contain one or more monosaccharide units of galactose, fructose, mannose, glucoside, glucose, xylose, arabinose, glucuronic acid and pyranosyl sulfate as well as locust bean gum, tara, xanthan, succinoglycan, scleroglucan and carrageenan.

Suitable hydratable polymers are those which contain one or more functional groups, such as a hydroxyl, carboxyl, sulfate, sulfonate, amino or amido groups may also be used. In addition to polysaccharides, preferred synthetic polymers include polyvinyl alcohols, polyacrylates (including the (meth)acrylates), polypyrrolidones, polyacrylamides (including (meth)acrylamides) as well as 2-acrylamido-2-methylpropane sulfonate and mixtures thereof.

Typically, the amount of viscosifying agent employed is between from about 15 to about 50, preferably from about 20 to about 30, pounds per 1,000 gallons of water in the fluid.

The pH of the fluid is typically in the range from about 6 to about 13. The fluid may contain a buffering agent or may be buffered by use of a gaseous foaming agent.

The fluid preferably contains a buffering agent when a gaseous foaming agent is not used or when a non-buffering gaseous foaming agent, such as nitrogen, is used. When a buffering agent is present in the fluid, the pH of the fluid is typically between from about 4.0 to about 4.8, preferably from about 4.45 to about 4.8. Suitable buffering agents include weak organic acids. When used with a gaseous foaming agent, such as carbon dioxide, the pH of the aqueous fluid is as low as 3.7.

The fracturing fluid may further contain any conventional proppant known in the art. Suitable proppants include sand, bauxite, ceramics as well as proppants having an apparent specific gravity (ASG) less than or equal to 2.45 commonly referred to as ultra lightweight (ULW) proppants. Generally the apparent specific gravity of such proppant is less than or equal to 2.25, typically less than or equal to 2.0, preferably less than or equal to 1.75, more preferably less than or equal to 1.25. ULW proppants more easily facilitate the placement of partial monolayers within the formation.

Exemplary ULW proppants for use in the invention include naturally occurring material resistant to deformation, a synthetic polymeric particulate, a porous particulate treated with a non-porous penetrating coating and/or glazing material or a well treating aggregate of an organic lightweight material and a weight modifying agent. Such ULW proppants are disclosed in U.S. Patent Publication No. 2008/0087429 A1, herein incorporated by reference. Further, the ULW proppant may be a polyamide, such as those disclosed in U.S. Patent Publication No. 2007/0209795 A1, herein incorporated by reference. The ULW proppant may be any of those deformable particulates set forth in U.S. Pat. No. 7,322,411, herein incorporated by reference. Still preferred are synthetic polymers, such as polystyrene beads crosslinked with divinylbenzene. Such beads include those described in U.S. Patent Publication No. 2007/0209794 A1, herein incorporated by reference. Mixtures of proppants may further be used.

The fluid of the invention may be prepared by batch mixing, continuous mixing, or other suitable methods known to those of skill in the art.

Exemplary of an operation using the fluid is that wherein the crosslinking agent is mixed into a solution containing the viscosifying agent, glutamic-N,N-diacetic acid and, when used, a non-gaseous buffering agent and the desired fluid viscosity is generated. In the case where a foam fluid is desired, the non-gaseous foaming agent may be added to the polymer solution prior to the addition of the crosslinking agent and crosslinking and delay agent. When desired, carbon dioxide, nitrogen or a mixture thereof may then be added. The fluid to which the crosslinking agent is added may further contain a low pH buffer when nitrogen gas is used to form the foam fluid.

A non-gaseous foaming agent may further be used and is often desirable when a gaseous foaming agent is not used. The non-gaseous foaming agent may be amphoteric, cationic or anionic. Suitable amphoteric foaming agents include alkyl betaines, alkyl sultaines and alkyl carboxylates.

The fluid may also contain additives typically used in the oil and gas industry and known in the art such as corrosion inhibitors, non-emulsifiers, reducing agents (such as stannous chloride), iron control agents, silt suspenders, flowback additives, gel breaker, surfactant, biocide, surface tension reducing agent, scale inhibitor, gas hydrate inhibitor, buffer, clay stabilizer, acid or a mixture thereof and other well treatment additives known in the art. The addition of such additives to the fluid minimizes the need for additional pumps required to add such materials on the fly.

Further, acceptable additives may also include internal gel breakers. (An external breaker, applied after the well treatment fluid is pumped into the formation, may further be used especially at elevated temperatures.) Breakers commonly used in the industry may be used including inorganic, as well as organic, acids, such as hydrochloric acid, acetic acid, formic acid, and polyglycolic acid; persulfates, like ammonium persulfate; calcium peroxide; sodium perborate; other oxidizers; antioxidizers; and mixtures thereof.

Further, the well treatment fluid may use an enzyme breaker. Typically, the enzyme breaker system is a mixture of highly specific enzymes which, for all practical purposes, completely degrade the backbone of the crosslinked polymer which is formed.

Proppants used in the fluid may be such conventional proppants as sand, bauxite and ceramics as well relatively lightweight proppants, such as those disclosed in U.S. Pat. Nos. 7,322,411; 7,971,643; 7,931,087; and 7,494,711, all of which are herein incorporated by reference.

The fluid of the invention has applicability in shale reservoirs, sandstone reservoirs as well as carbonate reservoirs, such as limestone or dolomite.

The following examples are illustrative of some of the embodiments of the present invention. Other embodiments within the scope of the claims herein will be apparent to one skilled in the art from consideration of the description set forth herein. It is intended that the specification, together with the examples, be considered exemplary only, with the scope and spirit of the invention being indicated by the claims which follow.

All percentages set forth in the Examples are given in terms of volume percent except as may otherwise be indicated.

### EXAMPLES

### Example 1

A fluid was prepared by first hydrating 1 liter of a 30 pounds per 1000 gal carboxymethyl guar linear gel for 30 minutes using a standard mixer at 1500 rpm. The contents were then poured into an OFITE sample cup and the viscosity of the linear gel was determined on a Model 900 viscometer, commercially available from OFI Testing Equipment, Inc. (OFITE) to confirm complete hydration. To the fluid was then added 3 gpt of sodium thiosulfate stabilizer (GS-1L, available from Baker Hughes Incorporated, 1 gpt potassium containing buffer capable of pH 10 (BF-9L, available from Baker Hughes Incorporated), and 1 gpt Claytreat-3C clay stabilizer, available from Baker Hughes Incorporated. To the base fluid was added either a 10% zirconium (IV) acetyl acetonate in methanol (ZR-IV-acac, available from SACHEM Europe B.V.) or a zirconate based crosslinker (XLW-14, available from Baker Hughes Incorporated).

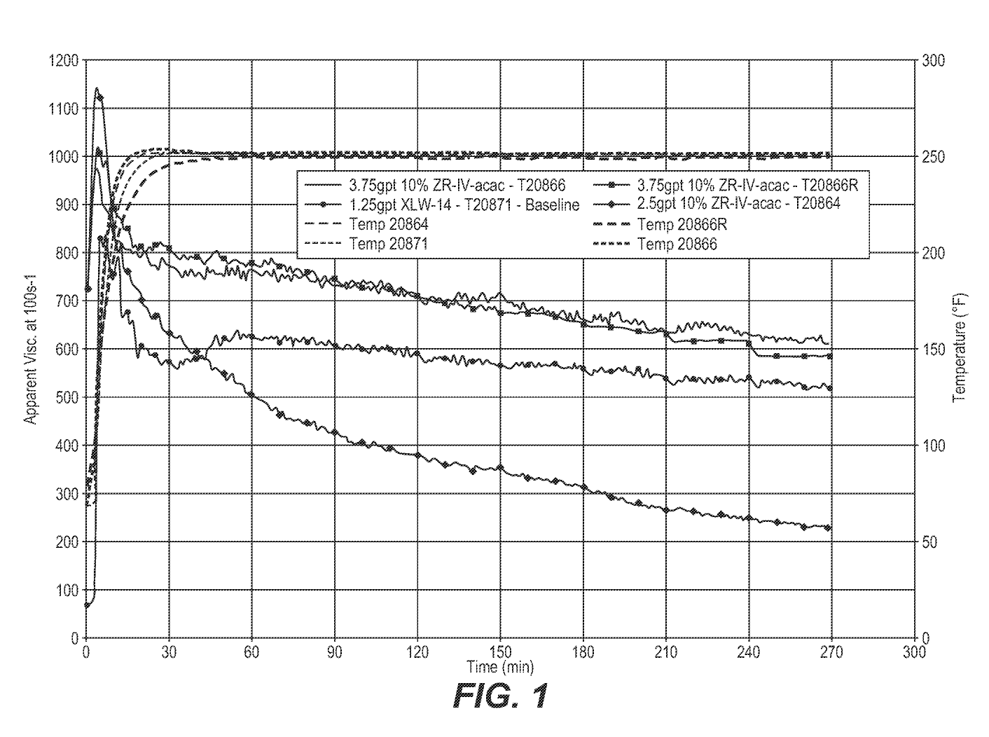

For Fann 50 testing, the fluid was initially sheared at 100 s⁻¹ followed by a shear rate sweep at 100, 80, 60, 40 s⁻¹ to calculate power law indices n and K. Fluid was sheared at 100 s⁻¹ in between shear rate sweeps and sweeps were repeated every 30 minutes. A RIBS rotor-bob configuration was used. Fluids were tested at 250° F. and the results are shown in FIG. 1. FIG. 1 suggests that the fluid with 3.75 gpt 10% ZR-IV-AcAc crosslinker showed fluid stability performance comparable to the fluid with 1.25 gpt XLW-14. However, the initial crosslink viscosity development with the 10% ZR-IV-AcAc crosslinker was much faster than XLW-14. The initial viscosity was 700 cP with 10% ZR-IV-acac crosslinker vs. 70 cP at 100 s⁻¹ with the XLW-14.

### Example 2

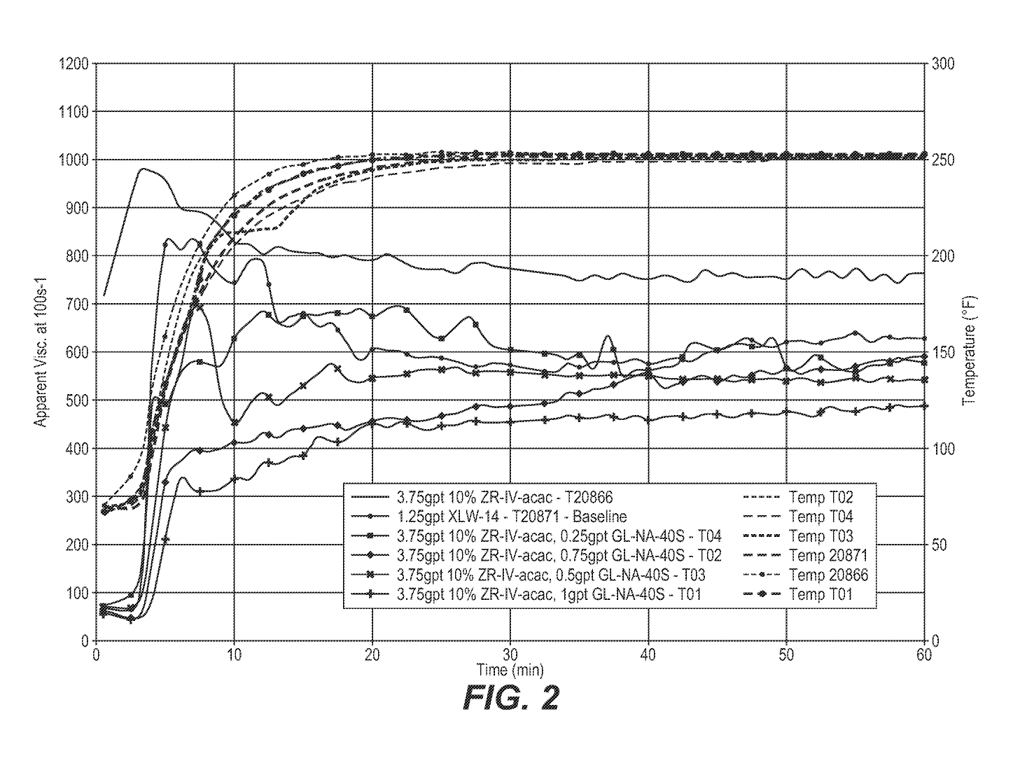

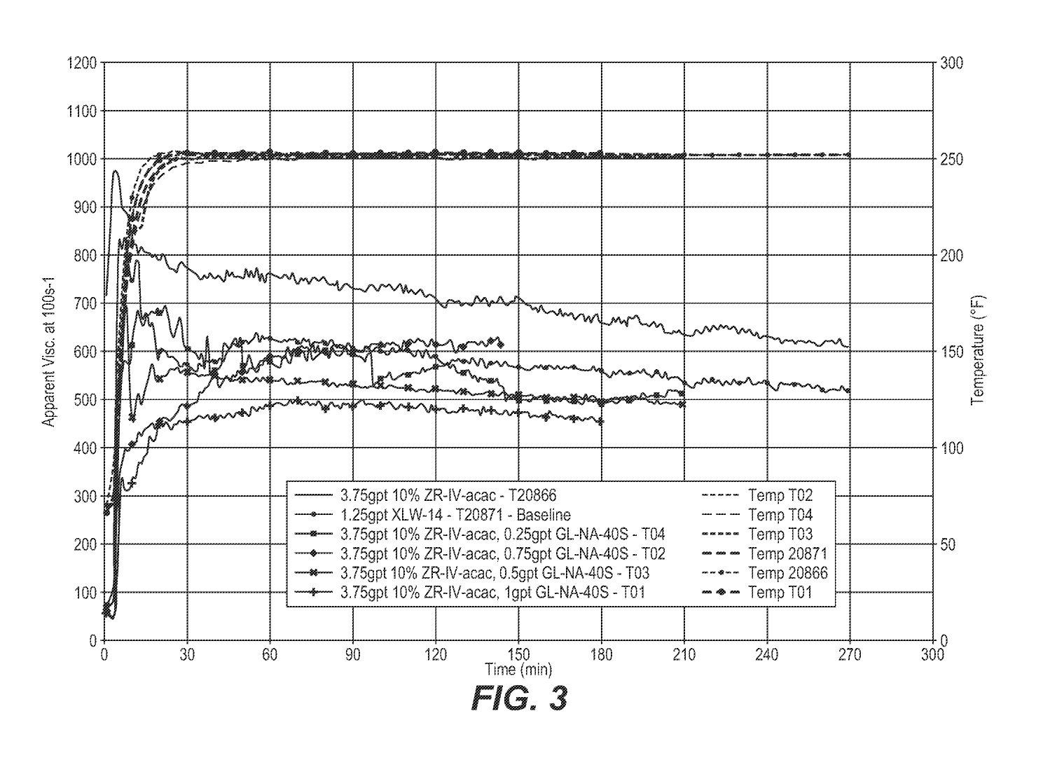

To the base fluid of Example 1 was added either ZR-IV-acac or XLW -14 and optionally glutamic acid-N,N-diacetic acid tetrasodium salt, 38% aqueous (Dissolvine GL-38-S, available from Akzo Nobel Polymer Chemicals, Amsterdam, Netherlands). FIGS. 2 and 3 show the results for crosslink delay with no high shear period. As demonstrated, the fluid with 0.25 gpt GL-NA-40S showed a similar delay time to the baseline fluid with XLW-14. The fluid with 0.25 gpt GL-NA-40S also showed comparable fluid stability performance to the baseline fluid with XLW-14. When the concentration of GL-NA-40S was higher than 0.5 gpt GL-NA-40S the fluid had a 30 minute delay in reaching peak viscosity. In all tests with the GL-NA-40S product the initial “peak” viscosity was lower than the “peak” viscosity obtained with the XLW-14 crosslinker.

### Example 3

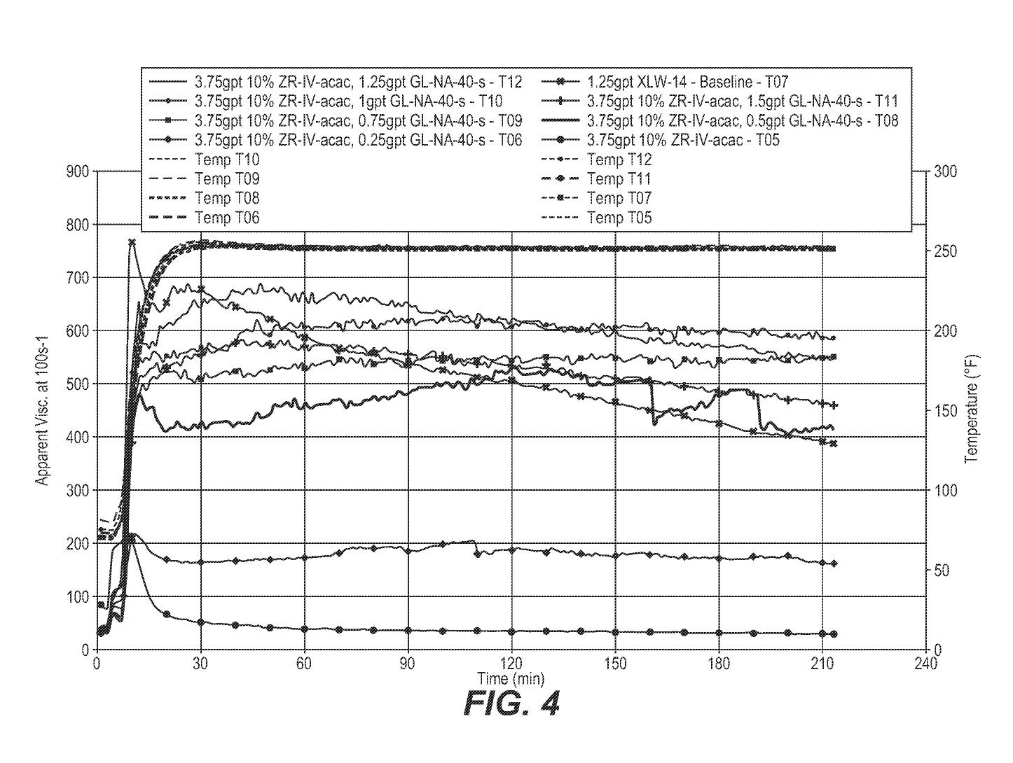

FIG. 4 shows the Fann 50 results of the fluid at 250° F. with a 3 minute initial high shear of 450 s⁻¹. FIG. 4 demonstrates that a concentration of 1.25 gpt GL-NA-40S showed slightly less initial “peak” viscosity but better stability than the XLW-14 crosslinker. Further, FIG. 4 shows that a minimum loading of 0.5 gpt GL-NA-40S was needed to show comparable fluid stability performance to the fluid with 1.25 gpt XLW-14 under the same conditions. As the concentration of the GL-NA-40S was increased from 0.5 to 1.25 gpt the fluid stability improved and initial “peak” viscosity increased. FIG. 4 does demonstrate that the concentration of the GL-NA-40S needed for optimization of fluid formulation varied depending on the high shear to which the fluid was exposed. The initial “peak” viscosity of all samples containing GL-NA-40S was lower than the “peak” viscosity obtained with the XLW-14 crosslinker.

From the foregoing, it will be observed that numerous variations and modifications may be effected without departing from the true spirit and scope of the novel concepts of the invention.

What is claimed is:

1. A method of fracturing a subterranean formation penetrated by a wellbore, the method comprising introducing into the wellbore at a pressure sufficient to enlarge or create a fracture a fluid comprising a viscosifying agent, a crosslinking agent containing titanium, zirconium, aluminum, iron or antimony or a mixture thereof, and a glutamic-N,N-diacetic acid salt.

2. The method of claim 1, wherein the crosslinking agent contains zirconium.

3. The method of claim 1, wherein the crosslink delaying agent is a glutamic-N,N-diacetic acid sodium salt.

4. The method of claim 1, wherein the crosslink delaying agent is tetrasodium glutamate diacetate.

5. The method of claim 2, wherein the zirconium crosslinking agent is selected from the group consisting of zirconium ammonium carbonate, zirconium chloride, sodium zirconium lactate, zirconium oxyacetate, zirconium acetate, zirconium oxynitrate, zirconium sulfate, tetrabutoxyzirconium, zirconium monoacetyl acetonate, zirconium normal butyrate, zirconium normal propylate, zirconium glycolate and zirconium lactate triethanolamine.

6. The method of claim 2, wherein the zirconium crosslinking agent is zirconium (IV) acetyl acetonate.

7. The method of claim 1, wherein the viscosifying agent is a polysaccharide.

8. The method of claim 7, wherein the viscosifying agent is guar or a guar derivative.

9. The method of claim 8, wherein the viscosifying agent is a carboxyalkyl guar or a hydroxyalkylated guar.

10. The method of claim 9, wherein the viscosifying agent is selected from the group consisting of carboxymethyl guar, hydroxypropyl guar, hydroxyethyl guar, hydroxybutyl guar and carboxymethylhydroxypropyl guar.

11. A method of fracturing a subterranean formation penetrated by a wellbore, the method comprising introducing into the wellbore at a pressure sufficient to enlarge or create a fracture a fluid comprising a viscosifying agent, a crosslinking agent containing titanium, zirconium, aluminum, iron or antimony or a mixture thereof, and a glutamic-N,N-diacetic acid tetrasodium, wherein the glutamic-N,N-diacetic acid tetrasodium salt is present at a concentration of from about 1 to about 10 pounds of glutamic-N,N-diacetic acid tetrasodium salt per 1,000 gallons of fracturing fluid.

12. The method of claim 11, wherein the crosslinking agent contains zirconium.

13. The method of claim 12, wherein the crosslinking agent is zirconium (IV) acetyl acetonate.

14. The method of claim 12, wherein the zirconium crosslinking agent is selected from the group consisting of zirconium ammonium carbonate, zirconium chloride, sodium zirconium lactate, zirconium oxyacetate, zirconium acetate, zirconium oxynitrate, zirconium sulfate, tetrabutoxyzirconium, zirconium monoacetyl acetonate, zirconium normal butyrate, zirconium normal propylate, zirconium glycolate and zirconium lactate triethanolamine.

15. The method of claim 11, wherein the viscosifying agent is a polysaccharide.

16. In a method of fracturing a subterranean formation of an oil or gas well to stimulate production of hydrocarbons by injecting at high pressure into the formation a fluid comprising a polysaccharide viscosifying agent, a zirconium crosslinking agent, and a crosslink delaying agent, the improvement comprising using as the crosslink delaying agent a glutamic-N,N-diacetic acid salt.

17. The method of claim 16, wherein the zirconium crosslinking agent is selected from the group consisting of zirconium ammonium carbonate, zirconium chloride, sodium zirconium lactate, zirconium oxyacetate, zirconium acetate, zirconium oxynitrate, zirconium sulfate, tetrabutoxyzirconium, zirconium monoacetyl acetonate, zirconium normal butyrate, zirconium normal propylate, zirconium glycolate and zirconium lactate triethanolamine.

18. The method of claim 16, wherein the zirconium crosslinking agent is zirconium (IV) acetyl acetonate.

19. The method of claim 16, wherein the crosslink delaying agent is a glutamic-N,N-diacetic acid sodium salt.

20. The method of claim 19, wherein the crosslink delaying agent is tetrasodium glutamate diacetate.
